(19) United States
(12) Patent Application Publication
(10) Pub. No.: US 2025/0109450 A1
(43) Pub. Date: Apr. 3, 2025

(54) METHOD AND DEVICE FOR PRODUCING DIRECT REDUCED METAL

(71) Applicant: GREENIRON H2 AB, Stockholm (SE)

(72) Inventor: Hans MURRAY, Djursholm (SE)

(21) Appl. No.: 18/864,429

(22) PCT Filed: May 17, 2023
(86) PCT No.: PCT/SE2023/050486

§ 371 Date: Nov. 8, 2024

(30) Foreign Application Priority Data
May 20, 2022 (SE) 2250610-9

(51) Int. Cl. C21B 13/00

(52) U.S. Cl. CPC C21B 13/0073; C21B 13/0093; C21B 2100/64; C21B 2100/66

(57) ABSTRACT

Method for producing direct reduced metal material (142), comprising the steps: a) charging material into a closed furnace space (120); b) filling the furnace space with heated inert gas, heating the material; c) providing a reducing gas; d) providing heat so that metal oxides present in the material are reduced, in turn causing water vapour to be formed; e) condensing and collecting the water vapour a condenser (160); and f) evacuating remaining reducing gas from the furnace space. The method is characterised in that the reducing gas has a lower density than the inert gas at the same pressure, and in that, in step c), the reducing gas is provided while the inert gas is still present in the furnace space, whereby the provided reducing gas as a result pushes the inert gas downwards, until the material (is entirely contained in reducing gas. The invention also relates to a system.

The present invention relates to a method and a device for producing direct reduced metal, such as direct reduced iron (also known as sponge iron). In particular, the present invention relates to the direct reduction of metal oxide or metal ore under a controlled hydrogen atmosphere to produce such direct reduced metal.

The production of direct reduced metal using hydrogen as a reducing agent is well-known as such. For instance, in SE7406174-8 and SE7406175-5 methods are described in which a charge of metal oxide or metal ore is subjected to a hydrogen atmosphere flowing past a charge of metal material, which as a result is reduced to form direct reduced pure metal.

Furthermore, in Swedish applications SE1950403-4, SE1951070-0 and SE2050771-1 processes for direct reducing metal material under a closed hydrogen atmosphere, and further to carburize such direct reduced metal material, are disclosed.

The present invention is particularly applicable in the case of batchwise charging and treatment of the metal material to be reduced.

There are several problems with the prior art, including efficiency regarding thermal losses as well as hydrogen gas usage.

It is also desirable to increase simplicity and procedural/time efficiency with respect to prior art solutions.

It would hence be desirable to achieve a thermally and energy efficient method for direct reducing of metal material that does not lead to the release into the atmosphere of carbon monoxide or carbon dioxide. The solution should be scalable to large throughputs and be capable of handling metal material of different constitutions.

The present invention solves the above described problems.

Hence, the invention relates to a method for producing direct reduced metal material, comprising the steps: a) charging metal material to be reduced into a closed furnace space; b) providing heat and an inert gas into the furnace space, whereby heated inert gas fills the furnace space and heats the charged metal material to a first temperature; c) providing a reducing gas to the furnace space; d) providing heat to the furnace space so as to maintain a second temperature in the charged metal material high enough so that metal oxides present in the charged metal material are reduced, in turn causing water vapour to be formed; e) condensing and collecting the water vapour formed in step d in a condenser); and f) evacuating remaining reducing gas from the furnace space after the charged metal material has been reduced, the method being characterised in that the reducing gas has a lower density than the inert gas at the same pressure, and in that, in step c), the reducing gas is provided while the inert gas is still present in the furnace space, whereby the provided reducing gas as a result pushes the inert gas downwards, until the charged metal material is entirely contained in reducing gas.

The invention also relates to a system for producing direct reduced metal material, comprising a furnace space, arranged to receive and accommodate metal material to be reduced; a heat and gas provision means arranged to provide heat, inert gas and reducing gas to the furnace space; a control device arranged to control the heat and gas provision means to provide heat and an inert gas into the furnace space, whereby heated inert gas fills the furnace space and heats the charged metal material to a first temperature; to provide a reducing gas to the furnace space; to provide heat to the furnace space so as to maintain a second temperature in the charged metal material high enough so that metal oxides present in the charged metal material are reduced, in turn causing water vapour to be formed; and to evacuate remaining reducing gas from the furnace space after the charged metal material has been reduced, wherein the system comprises a condenser arranged to condense and collect formed water vapour, the system being characterised in that the reducing gas has a lower density than the inert gas at the same pressure, and in that the control device is arranged to control the heat and gas provision means to provide the reducing gas while the inert gas is still present in the furnace space, whereby the provided reducing gas as a result pushes the inert gas downwards, until the charged metal material is entirely contained in reducing gas.

In the following, the invention will be described in detail, with reference to exemplifying embodiments of the invention and to the enclosed drawings, wherein:

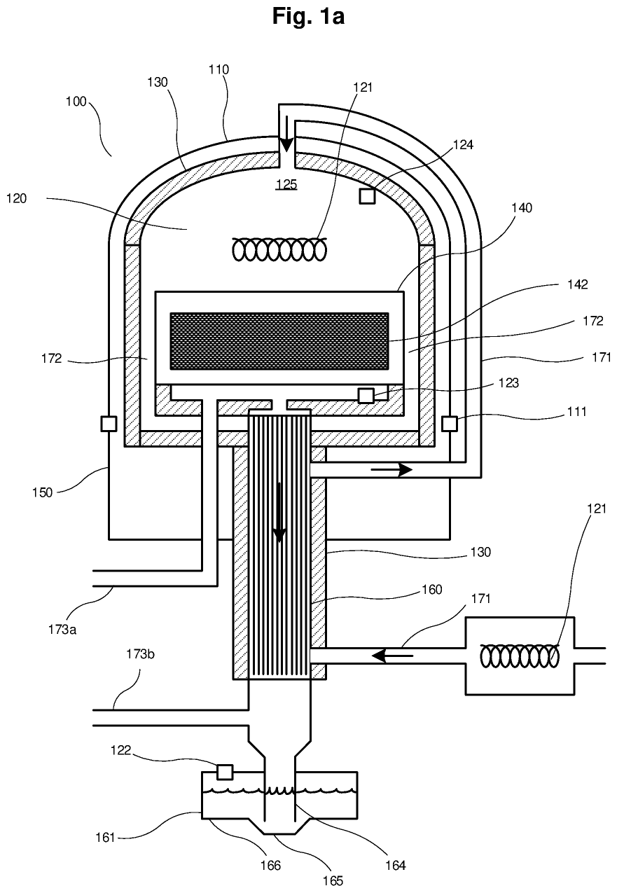

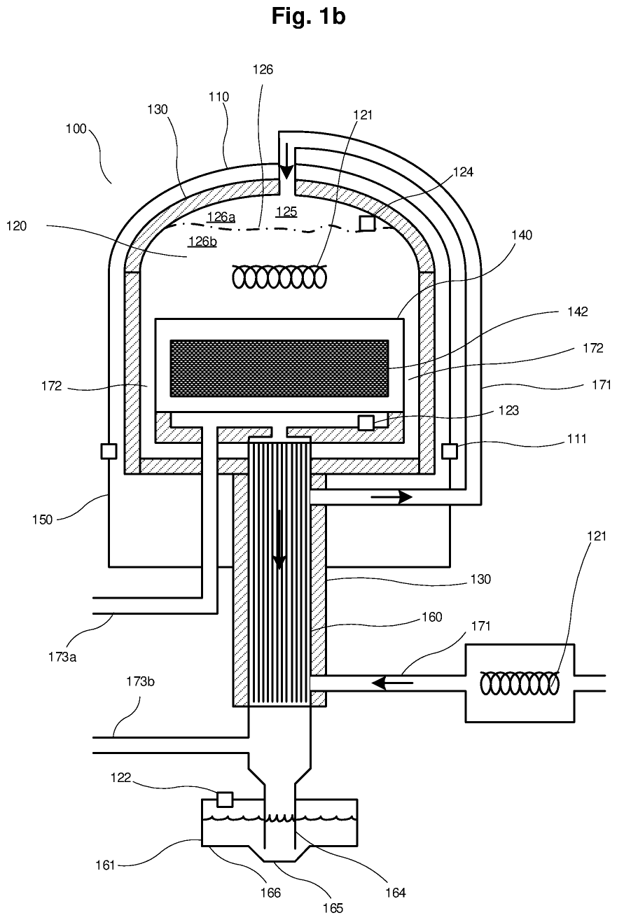

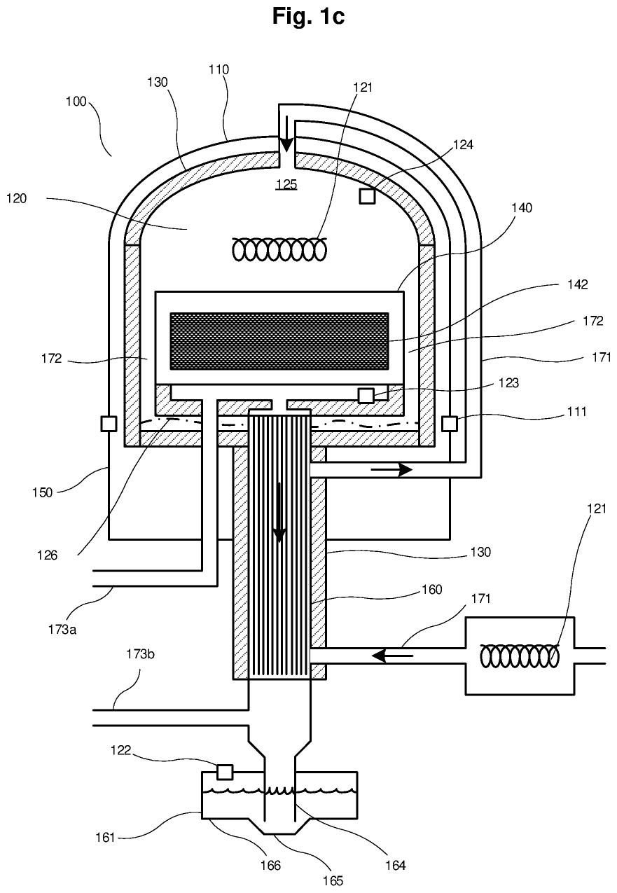

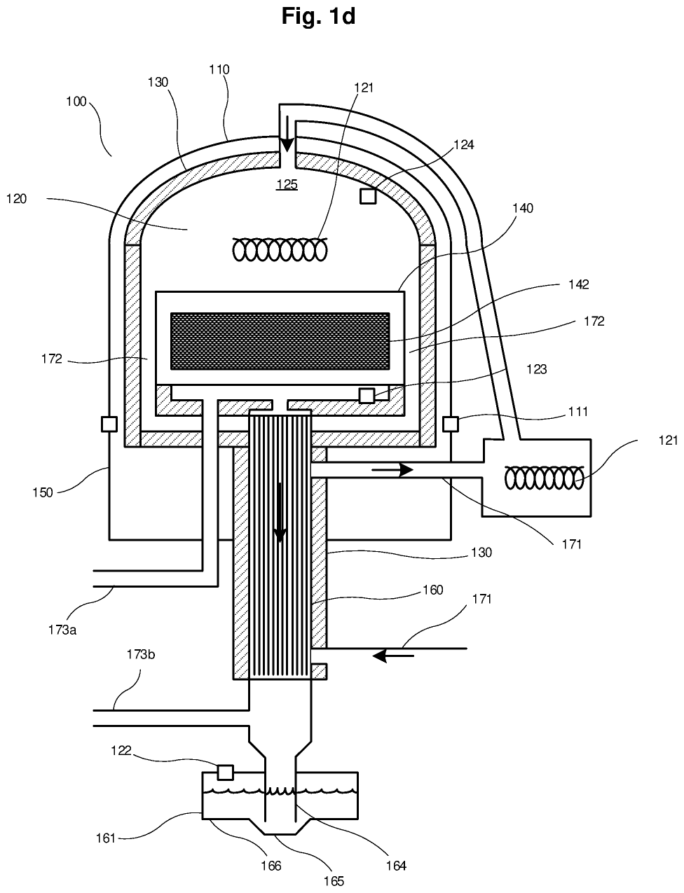

FIGS. 1a-1d are respective cross-sections of a simplified furnace for use in a system according to the present invention, during a first, second and third operation state;

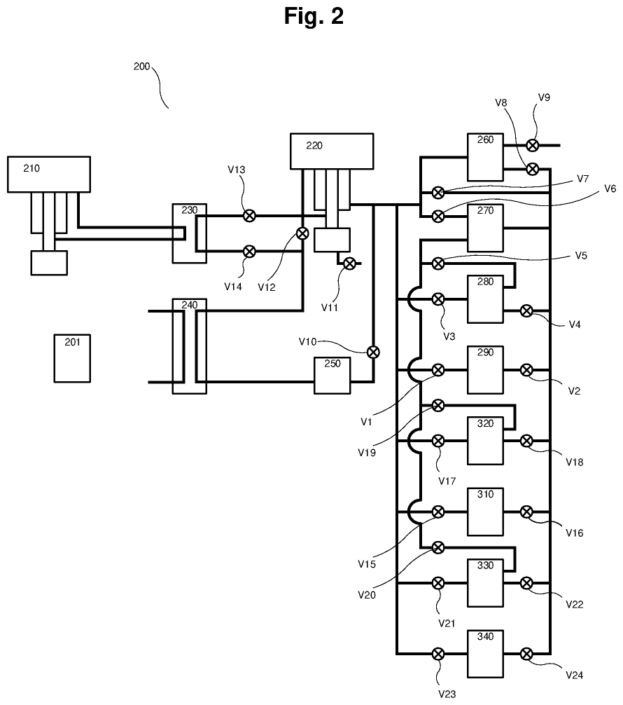

FIG. 2 is a schematic overview of a system according to the present invention;

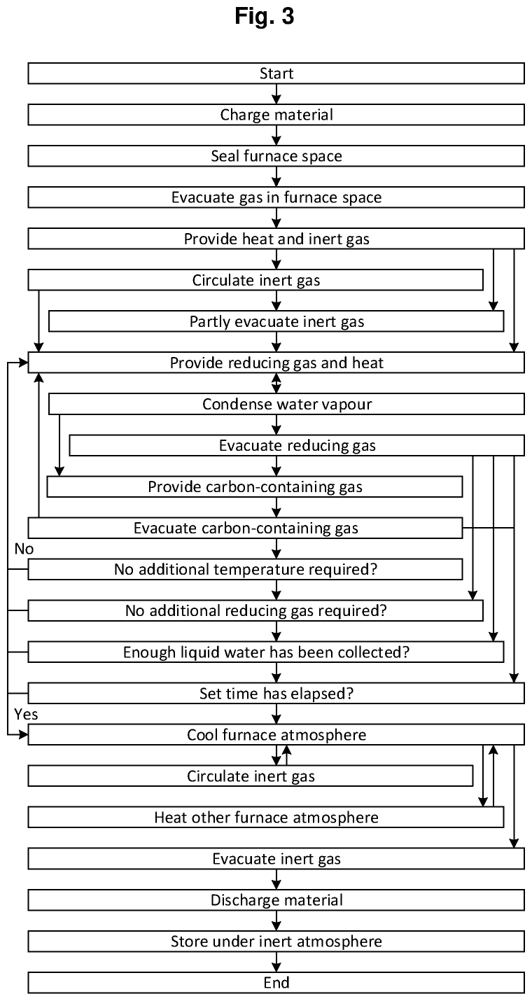

FIG. 3 is a flowchart of a method according to the present invention;

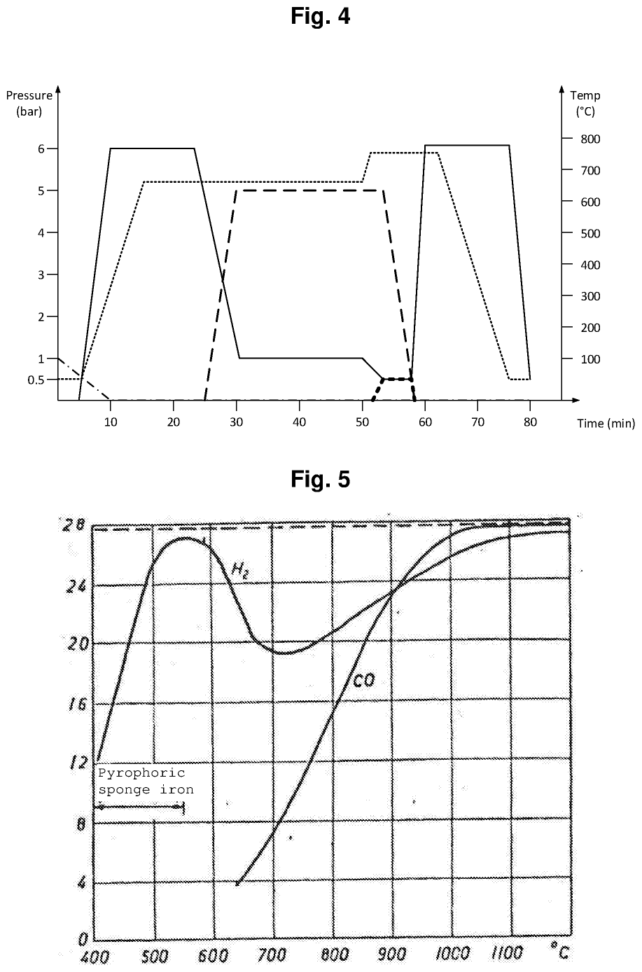

FIG. 4 is a chart illustrating the various steps in a method according to the present invention;

FIG. 5 is a chart showing the reductivity of H₂ with respect to Fe₃O₄ to be reduced, as a function of temperature (removed amount of oxygen in % on Y axis); and

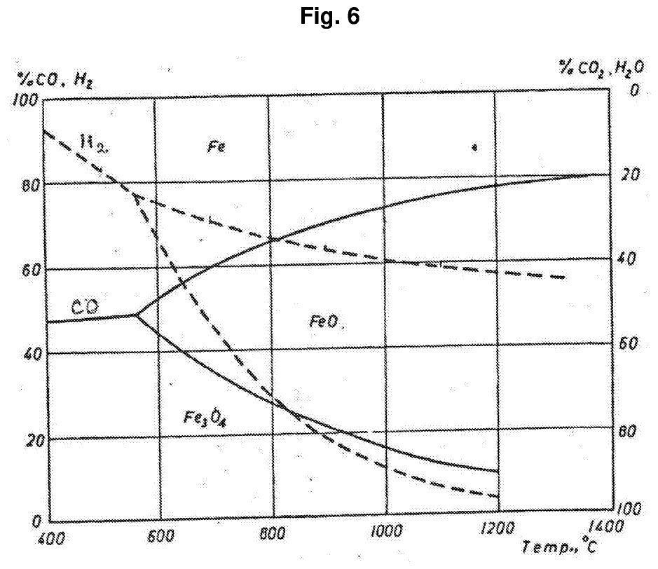

FIG. 6 is a diagram of the equilibrium in the reduction of iron oxides with hydrogen and carbon monoxide.

FIGS. 1a-1d share the same reference numerals for same parts.

Hence, FIGS. 1a-1d illustrate a furnace 100 for producing direct reduced and carburized metal material. In FIG. 2, two such furnaces 210, 220 are illustrated. The furnaces 210, 220 may be identical to furnace 100, or differ in details. However, it is understood that everything which is said herein regarding the furnace 100 is equally applicable to furnaces 210 and/or 220, and vice versa.

Furthermore, it is understood that everything which is said herein regarding the present method is equally applicable to the present system 200 and/or furnace 100; 210, 220, and vice versa.

The furnace 100 as such has many similarities with the furnaces described in SE7406174-8, SE7406175-5, SE1950403-4, SE1951070-0 and SE2050771-1, and reference is made to these documents regarding possible design details. However, an important difference between some of these furnaces and the present furnace 100 is that the present furnace 100 is not arranged to be operated in a way where reducing gas is recirculated through the furnace 100 and back to a collecting container arranged outside of the furnace 100, and in particular not in a way where reducing gas is recirculated out from the furnace 100 (or heated furnace space 120) and then back into the furnace 100 (or heated furnace space 120) during one and the same batch processing of charged material to be reduced.

Instead, and as will be apparent from the below description, the furnace 100 is arranged for batch-wise reducing and possibly carburizing operation of one charge of material at a time, and to operate during such an individual batch processing as a closed system, in the sense that reducing gas is supplied to the furnace 100 but not removed therefrom during the batch-wise reducing and carburizing process; and that carbon-containing gas may be supplied to the furnace 100 but not removed therefrom during the batchwise reducing and carburizing process described below.

This means that the amount of reducing gas present inside the furnace 100 is always maintained or increases during the reduction process. After reduction has been completed, the reducing gas is of course evacuated from within the furnace 100, but there is no recirculation of reducing gas during the reducing step. In some embodiments, as will become clear in the following, the corresponding is true also for the carbon-containing gas.

Hence, the furnace 100 is part of a closed system comprising a heated furnace space 120 which is arranged to be pressurized, such as to a pressure of more than 1 bar, such as to a pressure of at least 1.5 bar, or at least 2 bar, or at least 2.3 bar, or at least 2.5 bar, or at least 3 bar, or at least 4 bar, or at least 5 bar, or even at least 6 bar. Any of the pressurized processing steps (with respect to inert gas, reducing gas and/or carbon-containing gas) may be arranged to be performed up to and possibly maintaining a total pressure inside the furnace space 120 falling within any one of the pressure intervals mentioned previously in this paragraph. In particular, this applies to the below-discussed first and second operating pressures.

At any rate, the furnace space 120 is built to withstand the operating pressures described herein. An upper part 110 of the furnace 100 has a bell-shape. It can be opened for charging of material 142 to be processed, and can be closed in a gas-tight manner using fastening means 111. The furnace space 120 is encapsulated with refractory material, such as brick material 130.

If nothing else is said, the term “pressure” herein refers to a total gas pressure, in particular inside the furnace space 120, in contrast to a “partial pressure” referring to the partial gas pressure of a particular gas.

Furthermore, since atmospheric pressure is about 1 bar, the expression “pressure of more than 1 bar” and “pressure above atmospheric pressure” is intended to have the same meaning. Correspondingly, the expression “pressure of less than 1 bar” and “pressure below atmospheric pressure” is intended to have the same meaning.

The furnace space 120 is arranged to be heated using one or several heating elements 121. Preferably, the heating elements 121 are electric heating elements. However, radiator combustion tubes or similar fuel-heated elements can be used as well. The heating elements 121 do not, however, produce any combustion gases that interact directly chemically with the furnace space 120, which must be kept chemically controlled for the present purposes. It is preferred that the only gaseous matter provided into the furnace space during the below-described main heating process is reducing gas and any carbon-containing gas used as a carbon source for carburizing the metal material.

As is clear from FIGS. 1a-1d, the heating elements 121 may be arranged inside the furnace space 120 and/or outside of the furnace space 120. In the latter case, the heating elements 121 may be provided so that gas entering the furnace space 120 via a supply conduit 171 passes the heating elements 121 before entering the furnace space 120.

The heating elements 121 may preferably be made of a heat-resistant metal material, such as a molybdenum alloy.

Additional heating elements may also be arranged in the heated furnace space 120. For instance, heating elements similar to elements 121 may be provided at the side walls of the furnace space 120, such as at a height corresponding to the charged material or at least to the container 140. Such heating elements may aid heating not only the gas, but also the charged material via heat radiation.

As will be described below, a heat exchanger 160 is arranged to transfer thermal energy from outgoing gases from the furnace space 120 to incoming gases to the furnace space 120.

Additional thermal energy is required to heat the charged material 142, at least during the reducing step, as will be understood from the following. It is preferred that a majority, such as substantially all or all, of this additional thermal energy provided to the furnace space 120 during the reducing step is provided by heating elements 121 arranged outside of the furnace space 120 and arranged to heat incoming gases to the furnace space 120 before such gases enter the furnace space 120.

The furnace 100 also comprises a lower part 150, forming a sealed container together with the upper part 110 when the furnace is closed using fastening means 111.

A container 140 for material 142 to be processed (reduced and carburized) is present in the lower part 150 of the furnace 100. The container 140 may be supported on a refractory floor of the furnace space 120 in a way allowing gas to pass beneath the container 140, such as along open channels 172 formed in said floor.

The container 140 is preferably of an open constitution, meaning that gas can pass freely through at least a bottom/floor of the container 140. This may be accomplished, for instance, by forming holes through the bottom of the container 140.

The material to be processed comprises a metal oxide, preferably an iron oxide such as Fe₂O₃ and/or Fe₃O₄. The material may comprise scales or various types of scrap material. The material may be granular, such as in the form of pellets or balls, or made into such form in a suitable pre-processing step. One suitable material to be charged for batch reduction is rolled iron ore balls, for instance grinding waste rolled to balls, that have been rolled in water to a ball diameter of about 1-1.5 cm. If such material additionally contains oxides where the reduced metal evaporates at temperatures below the final temperature of the charged material in the present method, such metals may be condensed in the condenser 160 and easily collected in powder form. Such oxides may comprise metal oxides such as Zn and Pb oxides.

Advantageously, the furnace space 120 is not charged with very large amounts of material 142 to be reduced. Each furnace 100 is preferably charged with at the most 50 tonnes, such as at the most 25 tonnes, such as between 5 and 10 tonnes, in each batch. This charge may be held in one single container 150 inside the furnace space 120. Depending on throughput requirements, several furnaces 100 may be used in parallel, and the residual heat from a batch in one furnace 220 can then be used to preheat another furnace 210 (see FIG. 2 and below) or in a continuous system the cooling gas, that may preferably be an inert gas, can be used to preheat the incoming material.

This provides a system 200 which is suitable for installation and use directly at the mining or other material production site, requiring no expensive transport of the ore (or other material) before reduction. Instead, direct reduced and carburized metal material can be produced on-site, packaged under a protecting atmosphere and transported to a different site for further processing.

Hence, in the case of rolled iron ore balls or pellets, it is foreseen that the furnace 100 may be installed in connection to the iron ore ball or pellet production system, so that charging of the metal material into the furnace 100 in the container 140 can take place in a fully automated manner, where containers 140 are automatically circulated from the metal balls or pellets production system to the system 100 and back, being filled with metal balls or pellets to be reduced and carburized; inserted into the furnace space 120; subjected to the reducing and possible carburizing reducing gas/heat/carbon-containing gas processing described herein; removed from the furnace space 120 and emptied; taken back to the metal balls or pellets production system; refilled; and so forth. More containers 140 may be used than furnaces 100, so that in each batch switch a reduced and carburized charge in a particular container is immediately replaced in the furnace 100 with a different container carrying material not yet reduced and carburized. Such a larger system, such as at a mining site or a site producing other type of raw material, such as scales, may be implemented to be completely automated, and also to be very flexible in terms of throughput, using several smaller furnaces 100 rather than one very large furnace.

Below the container 140, the furnace 100 comprises the gas-gas type heat exchanger 160 (or a system comprises both the furnace 100 and the heat exchanger 160), which may advantageously be a tube heat exchanger such as is known per se. The heat exchanger 160 is preferably a counter-flow type heat exchanger. To the heat exchanger 160, below the heat exchanger 160, is connected a closed trough 161 for collecting and accommodating condensed water from the heat exchanger 160. The trough 161 is also constructed to withstand the operating pressures of the furnace space 120 in a gas-tight manner.

The heat exchanger 160 is connected to the furnace space 120, preferably so that cool/cooled gases arriving to the furnace space 120 via a supply conduit 171 pass the heat exchanger 160 along externally/peripherally provided heat exchanger tubes, and further up to a top part 125 of the furnace space 120 where they are released into the furnace space 120. Along this supply conduit, 171, such supplied gas may hence be heated by the heat exchanger and/or using heating elements 121.

In a way that will be described in detail below, heated gases pass out from the furnace space 120 in a downwards direction, pass the heat exchanger 160 through internally/centrally provided heat exchanger tubes, thereby heating said incoming cool/cooled gases. In the process, the downwards-passing gasses are cooled, and contained water vapour condenses into liquid water. The outgoing gases hence heat the incoming gases both by thermal transfer due to the temperature difference between the two, as well as by the condensing heat of condensing water vapour contained in the outgoing gases effectively heating the incoming gases.

The formed condensed water from the outgoing gases is collected in the trough 161.

The furnace 100 may comprise a set of temperature, flow and/or pressure sensors in the trough 161 (122); at the bottom of the furnace space 120, such as below the container 140 (123) and/or at the top of the furnace space 120 (124). These sensors may be used by control unit 201 to control the reduction and possible carburizing process, as will be described below.

173a and 173b denotes different exit conduits for gas from the furnace space 120, such as used inert or cooling gas. 173a is arranged to accept such gas from inside the furnace space 120 beneath the charged material 142 in the container 140; whereas 173b is arranged to accept such gas from downstream (such as below) the heat exchanger 160.

Condensed water may be led from the condenser/heat exchanger 160 down into the trough via a spout 164 or similar, debouching at a bottom of the trough 161, such as at a local low point 165 of the trough 161, preferably so that an orifice of said spout 164 is arranged fully below a main bottom 166 of the trough 161 such as is illustrated in FIGS. 1a-1d. This will decrease liquid water turbulence in the trough 161, providing more controllable operation conditions.

The trough 161 is advantageously dimensioned to be able to receive and accommodate all water formed during the reduction of the charged material. The size of trough 161 can hence be adapted for the type and volume of one batch of reduced material. For instance, when fully reducing and 1000 kg of Fe₃O₄, 310 liters of water is formed as a result, and when fully reducing 1000 kg of Fe₂O₃, 338 liters of water is formed as a result. In other embodiments, the collected water is diverted for waste disposal, depending on the degree of pollution. At any rate, it is preferred that the volume of the collected water is measured, such as using a per se conventional flow or level meter.

In FIG. 2, a system 200 is illustrated in which a furnace of the type illustrated in FIGS. 1a-1d may be put to use. In particular, one or both of furnaces 210 and 220 may be of the type illustrated in FIGS. 1a-1d, or at least according to the present claim 1.

230 denotes a gas-gas type heat exchanger. 240 denotes a gas-water type heat exchanger. 250 denotes a fan or pump. 260 denotes a vacuum pump. 270 denotes a compressor. 280 denotes a container for used reducing gas. 290 denotes a container for fresh/unused reducing gas. 310 denotes a container for fresh/unused carbon-containing gas. 320 denotes a container for used carbon-containing gas, such as a mixture of gas of the type stored in container 310 and reducing gas. 330 denotes a container for used inert gas, and 340 denotes a container for fresh inert gas. V1-V24 denote valves.

201 denotes a control device, which is connected to sensors 122, 123, 124 and valves V1-V24, and which is generally arranged to control the processes described herein. The control device 201 may also be connected to a user control device, such as a graphical user interface presented by a computer (not shown) to a user of the system 200 for supervision and further control.

FIG. 3 illustrates a method according to the present invention, which method uses a system 100 of the type generally illustrated in FIG. 2 and in particular a furnace 100 of the type generally illustrated in FIGS. 1a-1d. In particular, the method is for producing direct reduced and possibly carburized metal material using a reducing gas as the reducing agent and possibly a carbon-containing gas as a carburizing carbon source.

After such direct reduction and possible carburizing, the metal material 142 may form carburized or non-carburized sponge metal. In particular, the metal material may be iron oxide material, and the resulting product after the direct reduction may then be carburized sponge iron. The resulting reduced, possibly carburized metal material may then be used, in subsequent method steps, to produce steel and so forth.

In a first step, the method starts.

In a subsequent step, the metal material 142 to be reduced is charged into the furnace space 120. This charging may take place by a loaded container 140 being placed into the furnace space 120 in the orientation illustrated in FIGS. 1a-1d, and the furnace space 120 may then be closed and sealed in a gas-tight manner using fastening means 111.

In a subsequent step, an existing atmosphere may be evacuated from the furnace space 120, so that a gas pressure of less than 1 bar is achieved inside the furnace space 120. It is noted that this lower gas pressure is lower than atmospheric pressure. This may take place by valves 1-8, 11 and 13-24 being closed and valves 9-10 and 12 being open, and the vacuum pump 260 sucking out and hence evacuating the contained atmosphere inside the furnace space 120 via the conduit passing via 240 and 250. Valve 9 may then be open to allow such evacuated gases to flow out into the surrounding atmosphere, in case the furnace space 120 is filled with air. If the furnace space 120 is filled with used reducing and/or carbon-containing gas, this is instead evacuated to the container 280 or 320, as the case may be. Correspondingly, in case the furnace space 120 is filled with inert gas, this is instead evacuated to container 330.

In this example, the furnace atmosphere is evacuated via conduit 173a or 173b, even if it is realized that any other suitable exit conduit arranged in the furnace 100 may be used.

In this evacuation step, as well as in other steps as described below, the control device 201 may be used to control the pressure in the furnace space 120, such as based upon readings from pressure sensors 122, 123 and/or 124. The corresponding is also true regarding the below-described other evacuation and filling steps of various gases out from and into the furnace space 120.

The emptying may proceed until a pressure of at the most 0.5 bar, preferably at the most 0.3 bar, is achieved in the furnace space 120.

In a subsequent initial heating step, heat and inert gas is provided to the furnace space 120, whereby heated inert gas fills the furnace space 120 and heats the charged metal material 142 to a first temperature.

The inert gas may be supplied from the containers 330 and/or 340. Since the furnace 100 is closed, as mentioned above, substantially none of the provided gases, including the reducing gas and any carbon-containing gas and possibly also not any of the inert gas, will escape during the process. In other words, the gas losses (apart from reducing gas and any carbon-containing gas consumed in the reduction and carburization reactions) will be very low or even non-existent. Instead, only the reducing gas consumed chemically in the reduction reaction during the reduction process will be used, and correspondingly for any carbon-containing gas. Further, the only reducing gas which is required during the reduction process is the necessary amount to uphold the necessary pressure and chemical equilibrium between reducing gas and water vapour during the reduction process. This will be described in detail below.

As mentioned above, the container 340 holds fresh (unused) inert gas, while container 330 holds inert gas that has already been used in one or several reducing steps and has since been collected in the system 200. The first time the process is performed, only fresh inert gas is used, provided from container 340. During subsequent process runs, reused inert gas, from container 340, is used, which is topped up by fresh inert gas from container 340 according to need.

The corresponding is true regarding the reducing gas, being supplied from container 290 or 280, as the case may be; and for any carbon-containing gas, being supplied from container 310 or 320, respectively.

During an optional initial phase of the initial heating step, which initial phase is one of inert gas introduction, performed without any heat provision up to a furnace space 120 pressure of about 1 bar, or even up to about 2 bar, valves 1-9, 11 and 13-24 are closed, while valves 10 and 12 are open. Depending on if fresh or reused inert gas is to be used, valves V21 or V23 are also open, depending on the pressure if the compressor is needed the valves V6, V22 or V24 are open and V21 or V23 are closed.

As the pressure inside the furnace space 120 reaches, or comes close to, a desired pressure such as atmospheric pressure (about 1 bar), the heating element 121 inside or outside of the furnace 120 is switched on (in case this has not already taken place before). Preferably, it is the heating element 121 which provides the said heat to the furnace space 120, by heating the supplied (inert/reducing/carbon-containing) gas in question, which in turn heats the material 142 in the container 140. As has already been touched on above, the heating element 121 may be arranged at a location past which the inert/reducing/carbon-containing gas being provided to the furnace space 120 flows, so that the heating element 121 will be substantially submerged in (completely or substantially completely surrounded by) newly provided inert/reducing/carbon-containing gas during the initial heating, reducing and carburizing steps, respectively. In other words, the heat may advantageously be provided directly to the inert gas and/or directly to the reducing gas and/or directly to the carbon-containing gas, whichever gas is concurrently provided (in said initial or later steps) to the furnace space 120.

During the rest of the said initial heating step, valves V1-V5 and V7-V20 are closed, while valves V21-V24 and V6 are controlled by the control device, together with the compressor 270, to achieve a controlled provision of reused and/or fresh inert gas as described in the following.

Hence, during this initial heating step, the control device 201 is arranged to control the heat and inert gas provision means 121, 330, 340 to provide heat and inert gas to the furnace space 120. This may take place in a way so that heated inert gas heats the charged metal material 142 to a temperature above the boiling temperature of water contained in the metal material. As a result, said contained water evaporates.

During the initial heating step, the charged material 142 is heated to the first temperature, that may be a predetermined temperature, for instance such a temperature that is above the boiling point of water at prevailing pressures inside the furnace space 120. However, it is preferred that the first temperature to which the charged material is heated is a desired processing temperature during the subsequent reducing step, or at least within 100° C. of such a desired processing temperature. Such a desired processing temperature is in the following denoted a “second” temperature. It is noted that the second temperature in general will be significantly higher than the boiling temperature of water. In the example of reduction of iron oxide material, desired reduction processing temperatures (the second temperature) range from about 350° and upwards, such as 400°-700° or thereabout.

The inert gas may be nitrogen, but can also be any other suitable inert gas, such as a noble gas, or any mixtures of several such inert gases. The inert gas preferably has a lighter density, at same pressures, as water vapour.

In some embodiments, during the initial heating step, the inert gas is circulated in a closed loop past the charged metal material 142. For instance, the fan or pump 250 may be used to propel the inert gas in a closed-loop circuit past 230, 240, the furnace space 120 forming part of such closed-loop circuit, the inert gas flowing through and past the furnace space 120 on its way around the closed-loop circuit in question. Such circulation may take place during filling of the inert gas to a desired pressure (the “first” operating pressure) in the furnace space 120 and/or after such desired pressure has been reached. During circulation, the inert gas may be heated to finally assume said first temperature.

In some embodiments, during the initial heating step, the inert gas is provided at or up to a predetermined overpressure (again, the first operating pressure), the predetermined overpressure possibly being at least 2 bar, such as at least 3 bar. Then, before the subsequent reducing step the inert gas is again evacuated, such as to container 330, to a pressure which is lower than said overpressure. This lower pressure may be roughly 1 bar, such as 0.5-2 bar, such as 0.8-1.5 bar.

FIG. 1a illustrates the state of the furnace 100 during the heating step, in which the furnace space 120 is completely filled with inert gas.

FIG. 4 illustrates a timeline of an exemplifying process according to the present method. In FIG. 4, the full line illustrates a partial pressure (measured on the left vertical axis) of nitrogen (inert gas) as a function of time (horizontal axis); the dashed line illustrates a partial pressure (measured on the left vertical axis) of hydrogen (reducing gas) as a function of the same time; the dash-dotted line illustrates a partial pressure (measured on the left vertical axis) of air as a function of the same time; the sparsely dotted line illustrates a partial pressure (measured on the left vertical axis) of methane (carbon-containing gas) as a function of the same time; and the densely dotted line illustrates a furnace space 120 temperature (measured on the right vertical axis) as a function of the same time.

It is noted that FIG. 4 is merely provided for illustration of the presently described concepts, and is simplified for reasons of clarity.

As is clear from FIG. 4, the partial pressure of the inert gas increases along with temperature up to the first temperature (about 650° C. in this example), that in the case illustrated is the same as the second temperature, being a desired reducing-step processing temperature. The pressure and temperature is held for some time, while the inert gas may be circulated in said closed-loop circuit, at least until the charged material 142 has reached the first temperature and all or substantially all contained water has evaporated to form water vapour. As can be seen in FIG. 4, the air is first evacuated to about 0.5 bar, but as the air contains mostly nitrogen and oxygen the amount of air will decrease to about zero (note that FIG. 4 is a simplified view).

In a subsequent reducing step, the reducing gas is provided to the furnace space 120.

Before the reducing gas is supplied, the prevailing pressure of inert gas may first be reduced, by evacuating part of the inert gas, such as via exits 173a or 173b and to container 330 in the general manner discussed above, down to a desired predetermined total pressure inside the furnace space 120 to be used at the beginning of the reducing step. This predetermined pressure may be, for instance, at least 0.8 bar. The predetermined pressure may also be at the most 2 bar, such as at the most 1.5 bar. Most preferably, the predetermined pressure in question is about 1 bar. In the simple example provided in FIG. 4, however, the same total pressure of about 6 bar is substantially maintained throughout the process, so that the nitrogen gas is tapped off as the hydrogen gas is filled at the corresponding rate.

In other embodiments, the inert gas partial pressure, such as of 1-2 bar, may be maintained from the initial heating into and during the reduction phase.

As is illustrated in FIGS. 1a-1d, the reducing gas is preferably provided to a top part 125 of the furnace space 120, above the charged metal material 142. Preferably, the top part 125 is located so that the reducing gas is released into the furnace space 120 at a point which is less than 0.5 m from a top-most location of the furnace space 120. Preferably, the reducing gas is released into the furnace space 120 at least 0.3 meter, such as at least 0.5 meter, above a topmost point of the charged material 142.

Furthermore, in some embodiments, the reducing gas is provided in a flow that to at least dominant part is a laminar flow at a release point of the reducing gas into the furnace space 120. In other words, at least 50% of the volume of the released reducing gas flows laminarly at the point of release.

The reducing gas may be hydrogen or any other suitable reducing gas, for instance carbon monoxide. At any rate, it is preferred that the reducing gas has a density, at prevailing pressures in the furnace space 120, that is less than, preferably considerably less than, the inert gas, and also less than, preferably considerably less than, water vapour. Preferably, the inert gas is at least 5 times lighter than both the inert gas and water vapour. In the preferred case of using hydrogen as the reducing gas, hydrogen gas has a density that is only about 10% of the densities of nitrogen gas and water vapour, respectively, at the same pressure.

The laminar release flow aims at minimising the mixing of the inert gas and the reducing gas. Due to the said density difference, the reducing gas will strive upwards while the inert gas strives downwards, together with evaporated and formed (by the reduction process) water vapour. Depending on the detailed embodiment, for instance in terms of time and detailed furnace space 120 design, it is preferred to minimise mixing of the reducing gas and the inert gas using a laminar reducing gas release in said top part 125 of the furnace space 120.

For instance, the reducing gas can be released into the furnace space 120 via a porous block of ceramic material, or via a metal or refractory plate comprising a plurality of through holes, so as to spread the released reducing gas across a large surface. Such a release surface for the reducing gas may be at least 0.1 m², such as at least 0.2 m². Alternatively or in addition thereto, the opening of the conduit 171 into the furnace space 120 may be provided with a large cross-section, perpendicularly to a main reducing gas flow direction, such as of at least 0.02 m² or even at least 0.02 m².

As is understood from the above, when the release of the reducing gas commences, the furnace space 120 may already be completely filled with the inert gas. Then, as the reducing gas is released at the top part 125 of the furnace space 120, the reducing gas will occupy a top-most section of the furnace space 120 due to said density difference. A horizontal gas surface will be defined between the bodies of reducing gas and inert gas, the reducing gas due to its lower density pushing the surface and the inert gas downwards as the amount of reducing gas increases.

It is preferred that the reducing gas, while provided, is provided to the furnace space 120 without any recirculation of the reducing gas. Preferably, there is also no recirculation of the inert gas. That there is “no recirculation” means, in this context, that no reducing/inert gas is evacuated from the furnace space 120. In other words, all reducing/inert gas that is released into the furnace space 120 remains in the space defined by the furnace space 120 in combination with any peripheral space (such as the heat exchanger 160 and the trough 161) that together with the furnace space 120 forming a closed space for the gas. Preferably, this closed space also does not contain any closed-loop circulation loops of the above-discussed type, through which the gas is actively forced using a fan, a pump or similar. This is hence different from the circulation case described above, with respect to the inert gas during the heating step.

Instead, as the reducing gas is supplied to the furnace space 120, the pressure inside the furnace space 120 increases correspondingly as said surface moves downwards through the furnace space 120, unless the inert gas is simultaneously tapped from the bottom of the furnace space 120.

This downwards moving of the surface is illustrated in FIG. 4, from time 25 minutes and onwards. The situation after some time is also illustrated in FIG. 1b, where the surface boundary 126 between the upper reducing gas 126a and the lower inert gas 126b is still located above the material 142. In FIG. 1c, the surface boundary 126 is located completely below the charged material 142, in other words the material 142 is completely surrounded by the reducing gas.

Throughout the initial heating step, the reducing step and any carburizing step (see below), gas flows being provided to (or evacuated from) the furnace space 120 are controlled by the control device 201. As a result in the particular case of the reducing step, there will be a continuously present, relatively slow but steady, flow of reducing gas, increasing the total pressure inside the furnace space 120 and forcing the boundary surface 126 downwards. When the boundary surface 126 has reached the position illustrated in FIG. 1c, the set pressure should have be reached and additional reducing gas should only be added to compensate the reducing gas converted to water vapour.

It is furthermore understood that, in the reducing step, heat is provided to the furnace space 120 (via heating elements 121 and the heat exchanger 160 as described above) so as to reach (if not already prevalent) and maintain the second temperature in the charged metal material 142. The second temperature is high enough so that metal oxides present in the charged metal material 142 are reduced, in turn causing water vapour to be formed. This formed water vapour is condensed and collected in the condenser 160 as described above.

However, the reduction of the material 142 will not start until the reducing gas comes into contact with the material 142. Therefore, during the reducing step the reducing gas is provided while the inert gas is still present in the furnace space 120, as discussed above, and the control unit 201 is arranged to provide the flow of reducing gas so that, as a result of the provision of the reducing gas in turn pushing the boundary surface 126 downwards, the inert gas is pushed downwards until the charged metal material 142 is entirely contained in reducing gas. Due to the provided heat, the reducing gas surrounding the material 142 will hold the predetermined temperature despite the endothermal characteristics of the reduction process.

The charged material 142 will be kept completely surrounded by such hot reducing gas until the material 142 is fully reduced. The amount of holding time varies with the type of material, but it is foreseen that about 5-15 minutes will be enough in a typical case. During this time, the second operating pressure is maintained by the control device 201.

In general, the control device 201 is arranged to, during the reducing step, continuously add reducing gas, such as at the determined reduction temperature, so as to maintain at least a desired stable or increasing (such as monotonically increasing) reducing gas partial pressure curve (and also a total pressure curve) inside the furnace space 120, and in particular to counteract the decreased pressure at the lower parts of the furnace space 120 (and in the lower parts of the heat exchanger 160) resulting from the constant condensation of water vapour in the heat exchanger 160 (see below). The total energy consumption depends on the efficiency of the heat exchanger 160, and in particular its ability to transfer thermal energy to the incoming reducing gas from both the hot gas coming in to the heat exchanger 160 and the condensation heat of the condensing water vapour. In the exemplifying case of Fe₂O₃, the theoretical energy needed to heat the oxide, thermally compensate for the endothermic reaction and reduce the oxide is about 250 kWh per 1000 kg of Fe₂O₃, when using hydrogen as reducing gas. For Fe₃O₄, the corresponding number is about 260 kWh per 1000 kg of Fe₃O₄.

Once the charged material 142 is surrounded by the reducing gas, the reducing gas contacting the charged material 142 will form a gas mixture with water vapour from the reducing charged material. Since the water vapour is heavier than the reducing gas, the water vapour will flow downwards, into the inert gas beneath the reducing gas and further down to the condenser 160.

In the heat exchanger 160, there will then be a heat exchange of heat from the hot gas arriving from the furnace space 120 to the cold newly provided reducing gas arriving in conduit 171, whereby the latter will be preheated by the former.

Due to the cooling of the hot gas flow in the heat exchanger 160, water vapour contained in the cooled gas will condense. This condensation results in liquid water, which is collected in the trough 161, but also results in condensation heat. It is preferred that the heat exchanger 160 is further arranged to transfer such condensation thermal energy from the condensed water to the inert/reducing/carbon-containing gas to be provided into the furnace space 120.

The condensation of the contained water vapour will also decrease the pressure of the hot gas flowing downwards from the furnace space 120, providing space for more hot gas to pass downwards through the heat exchanger 160.

The condensation of the water vapour in the heat exchanger 160 will decrease the partial gas pressure for the water vapour at the lower end of the structure, further inducing a downwards flow of the water vapour generated in the charged material 142.

It is preferred that the reducing gas supplied to the heat exchanger 160, and also any carbon-containing gas supplied, is room tempered or has a temperature which is slightly less than room temperature. Hence, the heating element 121 shown as arranged upstream of the heat exchanger in FIGS. 1a-1c may, if used, instead be arranged along conduit 171 after (downstream of) the heat exchanger 160, at a location after the heat exchanger 160 and before reaching the release point at the top part 125 of the furnace space 120. This latter case is illustrated in FIG. 1d.

It is realised that the pressing down of the surface boundary 126 may be achieved by increasing the total pressure inside the furnace space 120, as illustrated in FIG. 4, while maintaining the partial pressure of the inert gas constant. However, in some embodiments, the inert gas may be evacuated to some degree, from a point beneath the charged material 142, such as via conduit 173a above the condenser 160 but preferably via conduit 173b below the condenser 160. Such an evacuation point is preferably located in a lower part of the furnace space 120 or completely below the furnace space 120.

A combination of a reducing gas partial pressure increase and an inert gas partial pressure decrease may also be used. This is then controlled by the control device 201. It is preferred, however, that no inert gas is evacuated from the closed space to which the furnace space 120 belongs during the reducing step. It is understood that the control device 201 needs to adjust the flow of the reducing gas (and any evacuation of the inert gas) to take into consideration the increased gas pressure due to the formed water vapour and the decreased gas pressure due to the condensation of the formed water vapour. Such regulation may be based on pressure measurements and/or experience. The important thing is the control over the vertical location of the boundary surface 126 so that all of the material 142 is in contact with the reducing gas.

Of course, during the reducing step that control device 201 is also arranged to correspondingly control the supplied heating (in 160, 201) so that the charged metal material 142 in turn is held at the second temperature, at which a reduction chemical reaction is maintained until completed.

In the case of hydrogen gas reducing iron oxide material, the hydrogen gas will start reducing the charged material 142 to form metallic iron at about 350-400° C., forming pyrophytic iron and water vapour according to the following formulae:

$${Fe}_{2} {O}_{3} + 3 {H}_{2} = 2 Fe + 3 {H}_{2} O \\ {Fe}_{3} {O}_{4} + 4 {H}_{2} = 3 Fe + 4 {H}_{2} O$$

As mentioned, this reaction is endothermal, and is driven by the thermal energy supplied via the hot hydrogen gas in the furnace space 120.

Hence, during the reducing step, water vapour is produced in the charged material. This formed water vapour is continuously condensed and collected in a condenser arranged below the charged metal material. In the example shown in FIGS. 1a-1d, the condenser is in the form of the heat exchanger 160.

As mentioned, in some embodiments of the present invention the reducing step, and possibly also any carburizing step, including said condensing of the water vapour, is performed so that a pressure (the second operating pressure) of more than 1 bar is built up in the furnace space 120 in relation to atmospheric pressure. In particular, the reducing gas is provided so that said pressure of more than 1 bar is achieved and maintained. It is noted that such a pressure of more than 1 bar is a pressure which is higher than atmospheric pressure.

Specifically, in the reducing step additional reducing gas may be provided to the furnace space 120 so as to achieve and/or maintain the predetermined overpressure (corresponding to the second operating pressure) therein.

In a subsequent reducing gas evacuation step performed after the metal material 142 has been reduced (preferably completely reduced or at least substantially completely reduced), the remaining reducing gas is evacuated from the furnace space 120. This evacuation of the reducing gas preferably takes place from an evacuation point at the top of the furnace space 120 (the same top as for the release of the reducing gas during the reducing step). For instance, the reducing gas may be evacuated via the same conduit 171 as used for releasing the reducing gas, but then in the reverse flow direction. The used reducing gas may be directed, under control of the control unit 201 as described above, to the container 280 for re-use in later processing cycles with new material to be reduced.

It is realised that, during the evacuation, the inert gas will push the reducing gas upwards as the pressure of the reducing gas decreases, whereby almost all of the reducing gas can be collected for reuse. This may involve the amount of inert gas in the closed system including the furnace space 120 staying the same throughout the evacuation, or additional inert gas being supplied from below, such as via supplies 173a or 173b, so as to increase the pressure in the furnace space 120. The evacuation may be back to atmospheric pressure in the furnace space 120, that then may be completely filled with inert gas. This may entail an evacuation of any surplus inert gas, preferably from an evacuation point below the material 142 as described above (from a point at a lower part of the furnace space 120 or below the furnace space 120 entirely).

The method may further comprise a carbonization step, namely a step in which a carbon-containing gas is provided to the furnace space 120, so that the metal material 142 that has been heated by said supplied heat and reduced by reaction with said reducing gas is carburized by said carbon-containing gas. This provision of carbon-containing gas may then be performed before an evacuation of the reducing gas from the furnace space 120 back to atmospheric pressure in the furnace space 120, by the carbon-containing gas being mixed with the reducing gas (and thereafter evacuated to container 280).

The carbon-containing gas may be any carbon-containing gas which can chemically react with the reduced metal material so as to carburize the latter. Examples of suitable carbon-containing gases comprise various gaseous (at the temperatures and pressures prevailing in the furnace space 120 during the performance of the present method) hydrocarbons, such as methane, ethane, propane, propene and similar. Preferably, the carbon-containing gas does not contain more than trace amounts of carbon monoxide, since this will efficiently prevent both carbon monoxide and carbon dioxide from forming residual products after the finalization of the present carburization process. In particular, it is preferred that no carbon monoxide is supplied to the furnace space 120 in said carbon-provision step. The carbon-containing gas should be less dense than the inert gas, such as is the case for methane and nitrogen (by way of example).

As described above, during reduction of iron free iron (Fe) is formed, which is then open for receiving carbon (C) to form Fe₃C.

FIG. 5 illustrates the ability for H₂ to reduce Fe₂O₃ as function of increasing temperature. As is hinted FIG. 5, reduction using hydrogen gas is particularly active in the temperature interval of roughly 400°-700°.

Correspondingly, carburization of the same Fe₂O₃ using a gaseous carbon source is most active in an interval stretching roughly between 650°-900°.

Fe₃O₄, for instance, displays similar properties with respect to reduction/carburization and temperature.

This means that a process that first performs most of the reduction of metal material at relatively lower temperatures, and then, after additional heating, performs most of the carburization of the metal material, will be efficient.

As is illustrated in FIG. 4, the subsequent carburizing step is performed at a third operating temperature being higher than the second operating temperature, such as between 650° C.-900° C. (in FIG. 4 about 750° C.). This operating temperature can be controlled by the control unit 201 by corresponding control of the heating elements 201.

As is also shown in FIG. 4, the provision of the carbon-containing gas also takes place together with a corresponding tapping off of inert gas, so that substantially the same total pressure is maintained inside the furnace space 120.

The subsequent carburizing step may also be performed at a third operating pressure that may be the same as, or different from, the second operating pressure.

It is also the case that the carburization process is aided by the presence of water vapour, which is one reason for performing the carburizing step and the reducing step at the same time, with mixed reducing and carbon-containing gases.

In the particular case of methane as the carbon-containing gas and hematite/magnetite as the metal material, the following carburizing chemical reactions then accrue in the furnace space 120:

$${Fe}_{3} {O}_{4} + 4 {H}_{2} = 3 Fe + 4 {H}_{2} O \\ 3 Fe + {CH}_{4} = {Fe}_{3} C + 2 {H}_{2}$$

The reaction between CH₄ and Fe comprises a sub reaction in which methane reacts with the water vapour formed by the reducing hydrogen gas:

$${CH}_{4} + {H}_{2} O = 2 CO + 3 {H}_{2}$$

Then, the carburization per se takes place mainly via the well-known hydrogen-water reaction, in which carbon monoxide and hydrogen react with the formed iron surface, and form water vapour, while the freed carbon atom can be taken up at the location for the previously freed oxygen atom.

Since the surface of the reduced iron is porous due to the reduction, the total iron surface area will typically be very large, leading to an efficient carburization process, in particular when the metal material 142 is provided as a granular material.

As can be seen from the above formulas, a certain amount of hydrogen gas is formed by the carburization process, why less hydrogen gas is required than what would have otherwise been the case.

It is preferred that the finally carburized metal material, after the finishing of the carbon-provision step, has a carbon content of between 1%-4% by weight.

In some embodiments, the reducing step, including any carbonizing step being performed at the same time as the reducing step, is performed during at least 10 minutes, such as at least 20 minutes, such as at least 30 minutes. In particular, it is preferred that the charged metal material 142 is completely surrounded by reducing gas during this period of time.

Correspondingly, this period of time may be at the most 30 minutes, such as at the most 15 minutes, such as at the most 10 minutes.

Moreover, the reducing step may be performed until no additional reducing gas is required to maintain a predetermined overpressure in the furnace space 120 and/or until a predetermined amount of liquid water has been collected in said condenser 160 and/or until no additional heat is required to maintain the second operating temperature in the furnace space 120. Such prevailing pressure, amount and temperature, as well as provided additional pressure or heat, may be measured as described above, and checked by the control device 201.

For these purposes, the third predetermined temperature mentioned above may be at least 600° C., such as between 640-750° C., preferably about 660° C.

The temperature of the charged material 142 may be measured directly, for instance by measuring heat radiation from the charged material 142 using as suitable sensor, or indirectly by temperature sensor 123.

Alternatively, the reducing and/or any carburizing step may be performed during a set time, based on experience.

In some embodiments, the reducing and/or any carburizing step may furthermore be performed iteratively, in each iteration the control device 201 allowing a steady state pressure to be reached inside the furnace space 120 before supplying an additional amount of reducing/carbon-containing gas into the furnace space 120. The heat provision may also be iterative (pulsed), or be in a switched on state during the entire reducing and/or carburizing steps.

The formation of water vapour in the charged material 142 increases the gas pressure locally, in effect creating a pressure variation between the furnace space 120 and the trough 161. As a result, formed water vapour will sink down through the charged material 142 and condense in the heat exchanger 160, in turn lowering the pressure on the distant (in relation to the furnace space 120) side of the heat exchanger 160. These processes thus create a downwards net movement of gas through the charge 142, where newly added hydrogen gas compensates for the pressure loss in the furnace space 120.

The thermal content in the gas flowing out from the furnace space 120, and in particular the condensing heat of the water vapour, is transferred to the incoming inert/hydrogen/carbon-containing gas in the heat exchanger 160.

Hence, the reduction process is maintained as long as there is metal material to reduce and water vapour hence is produced, resulting in said downwards water vapour gas movement. Once the production of water vapour stops (due to substantially all metal material 142 having been reduced), the pressure equalizes throughout the interior of the furnace 100, and the measured temperature will be similar throughout the furnace space 120, in case no additional reducing (or carbon-containing) gas is supplied. For instance, a measured pressure difference between a point in the gas-filled part of the trough 161 and a point above the charged material 142 will be less than a predetermined amount, which may be at the most 0.1 bar. Additionally or alternatively, a measured temperature difference between a point above the charged material 142 and a point below the charged material but on the furnace space 120 side of the heat exchanger will be less than a predetermined amount, which may be at the most 20° C. Hence, when such pressure and/or temperature homogeneity is reached and measured, the reducing step may be stopped.

Normally, the heating element 121 is not switched off until the carburization (if used in the method) has finished, which will normally occur at a later point in time.

After full reduction and carburization has occurred, the method according to the present invention may comprise a cooling step and an emptying step, that will be described in the following.

Hence, in a subsequent cooling step, the remaining inert gas atmosphere in the furnace space 120 is cooled to a temperature of at the most 100° C., preferably about 50° C., and is thereafter evacuated from the furnace space 120 and collected, such as into container 330.

In the case of a single furnace 100/220, which is not connected to one or several furnaces, the charged material 142 may be cooled using the fan 250, which is arranged downstream of the gas-water type cooler 240, in turn being arranged to cool the inert gas (such as circulated in a closed loop by the fan 250 in a loop past the valve V12, the heat exchanger 240, the fan 250 and the valve V10, exiting the furnace space 120 via exit conduit 173a or 173b and again entering the furnace space 120 via entry conduit 171).

The heat exchanger 240 hence transfers the thermal energy from the circulated inert gas to water (or a different liquid), from where the thermal energy can be put to use in a suitable manner, for instance in a district heating system. The closed loop is achieved by closing all valves V1-V24 except valves V10 and V12.

Since the inert gas in this case is circulated past the charged material 142 in the container 140, it absorbs thermal energy from the charged material 142, providing efficient cooling of the charged material while the inert gas is circulated in a closed loop.

In a different example, the thermal energy available from the cooling of the furnace 100/220 is used to preheat a different furnace 210. This is then achieved by the control device 201, as compared to the above described cooling closed loop, closing the valve V12 and instead opening valves V13, V14. This way, the hot inert gas arriving from the furnace 220 is taken to the gas-gas type heat exchanger 230, which is preferably a counter-flow heat exchanger, in which reducing gas being supplied in a reducing step performed in relation to the other furnace 210 is preheated in the heat exchanger 230. Thereafter, the somewhat cooled gas from furnace 220 may be circulated past the heat exchanger 240 for further cooling before being reintroduced into the furnace 220. Again, the inert gas from furnace 220 is circulated in a closed loop using the fan 250.

Hence, the cooling of the inert gas in the cooling step may take place via heat exchange with reducing gas to be supplied to a different furnace 210 space 120 for performing the reducing step and the condensation, as described above, in relation to said different furnace 210 space 120.

Once the inert gas is insufficiently hot to heat the reducing gas supplied to furnace 210, the control device 201 again closes valves V13, V14 and reopens valve V12, so that the reducing gas from furnace 220 is taken directly to heat exchanger 240.

Irrespectively of how its thermal energy is taken care of, the inert gas from furnace 220 may be cooled until it (or, more importantly, the charged material 142) reaches a temperature of below 100° C., in order to avoid reoxidation of the charged material 142 when later being exposed to air. The temperature of the charged material 142 can be measured directly, in a suitable manner such as the one described above, or indirectly, by measuring in a suitable manner the temperature of the inert gas leaving via exit conduit 173.

The cooling of the inert gas may take place while maintaining the pressure of the inert gas (which may be above atmospheric pressure after the evacuation of the reducing and any carbon-containing gas), or the pressure of the inert gas may be lowered as a result of the hot inert gas being allowed to occupy a larger volume (of the closed loop conduits and heat exchangers) once valves V10 and V12 are opened.

In a subsequent step, the inert gas is evacuated from the furnace 220 space 120, and collected in container 330 for used inert gas, using the vacuum pump 260, possibly in combination with the compressor 270. The evacuation of the furnace space 120 is preferably performed until a pressure of at the most 0.5 bar, or even at the most 0.3 bar, is detected inside the furnace space 120.

Since the furnace space 120 is closed, only the reducing/carbon-containing gas consumed in the chemical reduction reaction has been removed from the system, and the remaining reducing gas is the one which was necessary to maintain the reducing gas/water vapour balance in the furnace space 120 during the reducing step. This evacuated reducing gas is fully useful for a subsequent batch operation of a new charge of metal material to be reduced.

Thereafter, valves V7, V8 are closed an and valve V9 is opened to allow air into the system for change of the charged material, and valve V11 is opened for emptying of the condensate water, as applicable.

In a subsequent step, the furnace space 120 is opened, such as by releasing the fastening means 111 and opening the upper part 110. The container 140 is removed and is replaced with a container with a new batch of charged metal material to be reduced.

In a subsequent step, the removed, reduced material may then be arranged under an inert atmosphere, such as a nitrogen atmosphere, in order to avoid reoxidation during transport and storage.

For instance, the reduced metal material may be arranged in a flexible or rigid transport container which is filled with inert gas. Several such flexible or rigid containers may be arranged in a transport container, which may then be filled with inert gas in the space surrounding the flexible or rigid containers. Thereafter, the reduced metal material can be transported safely without running the risk of reoxidation.

In a subsequent step, the method ends.

The following table shows the approximate equilibrium between hydrogen gas H₂ and water vapour H₂O for different temperatures inside the furnace space 120:

| Temperature (° C.): | 400 | 450 | 500 | 550 | 600 |
|---|---|---|---|---|---|
| H₂ (vol-%): | 95 | 87 | 82 | 78 | 76 |
| H₂O (vol-%): | 5 | 13 | 18 | 22 | 24 |

About 417 Nm³ hydrogen gas H₂ is required to reduce 1000 kg of Fe₂O₃, and about 383 m³ hydrogen gas H₂ is required to reduce 1000 kg of Fe₃O₄.

The following table shows the amount of hydrogen gas required to reduce 1000 kg of Fe₂O₃ and Fe₃O₄, respectively, at atmospheric pressure and in an open system (according to the prior art), but at different temperatures:

| Temperature (° C.): | 400 | 450 | 500 | 550 | 600 |
|---|---|---|---|---|---|
| Nm³ H₂/tonne Fe₂O₃: | 8340 | 3208 | 2317 | 1895 | 1738 |
| Nm³ H₂/tonne Fe₃O₄: | 7660 | 2946 | 2128 | 1741 | 1596 |

The following table shows the amount of hydrogen gas required to reduce 1000 kg of Fe₂O₃ and Fe₃O₄, respectively, at different pressures and for different temperatures:

| Temperature (° C.): | 400 | 450 | 500 | 550 | 600 |
|---|---|---|---|---|---|
| Nm³ H₂/tonne Fe₂O₃: | | | | | |
| 1 bar | 8340 | 3208 | 2317 | 1895 | 1738 |
| 2 bar | 4170 | 1604 | 1158 | 948 | 869 |
| 3 bar | 2780 | 1069 | 772 | 632 | 579 |
| Nm³ H₂/tonne Fe₃O₄: | | | | | |
| 1 bar | 7660 | 2946 | 2128 | 1741 | 1596 |
| 2 bar | 3830 | 1473 | 1064 | 870 | 798 |
| 3 bar | 2553 | 982 | 709 | 580 | 532 |

As described above, the reducing step according to the present invention is preferably performed up to a pressure of more than 1 bar and a high temperature. During the majority of a part of the reducing step in which part reduction is ongoing, it has been found advantageous to use a combination of a heated hydrogen gas temperature of at least 550° C. and a furnace space 120 pressure of at least 2.3 bar.

Above, preferred embodiments have been described. However, it is apparent to the skilled person that many modifications can be made to the disclosed embodiments without departing from the basic idea of the invention.

For instance, the geometry of the furnace 100 may differ, depending on the detailed prerequisites.

The heat exchanger 160 is described as a tube heat exchanger. Even if this has been found to be particularly advantageous, it is realized that other types of gas-gas heat exchangers/condensers are possible. Heat exchanger 240 may be of any suitable configuration.

The surplus heat from the cooled inert gas may also be used in other processes requiring thermal energy.

The metal material to be reduced and carburized has been described as iron oxides. However, the present method and system can also be used to reduce and carburize metal material such as the above mentioned metal oxides containing Zn and Pb, that evaporate at temperatures below about 600-700° C.

The present combined direct reduction and possible carburizing principles can also be used with metal materials having higher reduction temperatures than iron ore, with suitable adjustments to the construction of the furnace 100, such as with respect to used construction materials.

Hence, the invention is not limited to the described embodiments, but can be varied within the scope of the enclosed claims.

1. A method for producing direct reduced metal material, comprising the steps:
a) charging metal material to be reduced into a closed furnace space;
b) providing heat and an inert gas into the furnace space, whereby heated inert gas fills the furnace space and heats the charged metal material to a first temperature;
c) providing a reducing gas to the furnace space;
d) providing heat to the furnace space so as to maintain a second temperature in the charged metal material high enough so that metal oxides present in the charged metal material are reduced, in turn causing water vapour to be formed;
e) condensing and collecting the water vapour formed in step d in a condenser; and
f) evacuating remaining reducing gas from the furnace space after the charged metal material has been reduced,
wherein the reducing gas has a lower density than the inert gas at the same pressure, and wherein, in step c), the reducing gas is provided while the inert gas is still present in the furnace space, whereby the provided reducing gas as a result pushes the inert gas downwards, until the charged metal material is entirely contained in reducing gas.

2. The method according to claim 1, wherein, in step b), the inert gas is circulated in a closed loop past the charged metal material.

3. The method according to claim 1, wherein, in step b), the inert gas is provided at a predetermined overpressure, and wherein, before step c) the inert gas is evacuated to a pressure which is lower than said overpressure.

4. The method according to claim 1, wherein, in step c), the reducing gas is provided to a top part of the furnace space, above the charged metal material.

5. The method according to claim 4, wherein, in step c), the reducing gas is provided in a flow that to at least dominant part is a laminar flow.

6. The method according to claim 1, wherein, in steps c)-e), the reducing gas is provided to the furnace space without any recirculation of neither the reducing gas nor the inert gas.

7. The method according to claim 1, wherein, in step d), additional reducing gas is provided to the furnace space so as to achieve and/or maintain a predetermined overpressure therein.

8. The method according to claim 1, wherein the method comprises evacuating the inert gas from the furnace space from a lower part of the furnace space or a point below the furnace space, beneath the charged metal material.

9. The method according to claim 1, wherein, in step f), the remaining reducing gas is evacuated from the furnace space from a top part of the furnace space, above the charged metal material.

10. The method according to claim 9, wherein step f) results in the furnace space is filled with inert gas, and wherein the method further comprises a subsequent step in which the inert gas is circulated in a closed loop so as to cool the reduced metal material.

11. The method according to claim 1, wherein the method further comprises the initial step of evacuating an existing atmosphere from the furnace space so as to achieve a gas pressure of less than 1 bar, such as at the most 0.5 bar, inside the furnace space.

12. The method according to claim 1, wherein the method further comprises providing a carbon-containing gas, such as a gaseous hydrocarbon, to the furnace space, so that the heated and reduced metal material is carburized by said carbon-containing gas.

13. The method according to claim 1, wherein the reducing gas is hydrogen gas and/or carbon monoxide.

14. The method according to claim 1, wherein the inert gas is nitrogen.

15. The method according to claim 1, wherein the reducing gas is preheated in a heat exchanger, which heat exchanger is arranged to transfer thermal energy from water evaporated from the charged metal material to the reducing gas.

16. The method according to claim 1, wherein steps d) and e) are performed until no additional reducing gas is required to maintain a predetermined overpressure in the furnace space and/or until a predetermined amount of liquid water has been collected in said condenser and/or until no additional heat is required to maintain the second temperature in the furnace space.

17. The method according to claim 3, wherein the predetermined overpressure is an absolute pressure of at least 2.3 bar, such as at least 2.5 bar, such as at least 3 bar.

18. The method according to claim 1, wherein steps d) and e) are performed during at least 2 minutes, such as at least 3 minutes, for an amount of metal material of up to 5 tonnes; and wherein steps d) and e) are performed during at least 5 minutes, such as at least 10 minutes, for an amount of metal material of up to 10 tonnes.

19. The method according to claim 1, wherein steps d) and e) are performed during at the most 30 minutes, such as at the most 15 minutes, such as at the most 10 minutes, for an amount of metal material of up to 5 tonnes; and wherein steps d) and e) are performed during at the most 60 minutes, such as at the most 30 minutes, such as at the most 15 minutes, for an amount of metal material of up to 10 tonnes.

20. A system for producing direct reduced metal material, comprising
a furnace space, arranged to receive and accommodate metal material to be reduced;
a heat and gas provision means arranged to provide heat, inert gas and reducing gas to the furnace space;
a control device arranged to control the heat and gas provision means to provide heat and an inert gas into the furnace space, whereby heated inert gas fills the furnace space and heats the charged metal material to a first temperature; to provide a reducing gas to the furnace space; to provide heat to the furnace space so as to maintain a second temperature in the charged metal material high enough so that metal oxides present in the charged metal material are reduced, in turn causing water vapour to be formed; and to evacuate remaining reducing gas from the furnace space after the charged metal material has been reduced,
wherein the system comprises a condenser arranged to condense and collect formed water vapour,
wherein the reducing gas has a lower density than the inert gas at the same pressure, and wherein the control device is arranged to control the heat and gas provision means to provide the reducing gas while the inert gas is still present in the furnace space, whereby the provided reducing gas as a result pushes the inert gas downwards, until the charged metal material is entirely contained in reducing gas.

21. The method according to claim 7, wherein the predetermined overpressure is an absolute pressure of at least 2.3 bar, such as at least 2.5 bar, such as at least 3 bar.

22. The method according to claim 13, wherein the predetermined overpressure is an absolute pressure of at least 2.3 bar, such as at least 2.5 bar, such as at least 3 bar.
